(19) United States
(12) Patent Application Publication
(10) Pub. No.: US 2013/0145678 A1
(43) Pub. Date: Jun. 13, 2013

(54) Fisherman's flute

(71) Applicants: Hugo Bosch, Miami, FL (US); Osvaldo Aguilar, Miami, FL (US)

(72) Inventors: Hugo Bosch, Miami, FL (US); Osvaldo Aguilar, Miami, FL (US)

(21) Appl. No.: 13/200,578

(22) Filed: Dec. 13, 2011

(51) Int. Cl. A01K 97/06

(52) U.S. Cl. 43/57.2

(57) ABSTRACT

An apparatus for carrying or transport fishing leaders, with the idea of protecting fishermen from injuries while handling or transporting fishing leaders and also avoid the hassle of tangled fishing leaders. The apparatus will enable the fisherman to have handy and readily available fishing leaders, saving precious time while fishing. The apparatus has several sections in its body so as to house leaders of different sizes. The apparatus is basically two PVC pipes partially sliding one within the other, with a spring in its interior so as to keep the leaders always stretched.

This invention is a fisherman utility to safely hold and transport fishing leaders. The apparatus allows the fisherman to carry several leaders in an orderly and condensed manner, without been exposed to the sharp points of fishing hooks, furthermore, the apparatus removes the nightmare that fishermen experience when they buy leaders and takes the first one out of the original package, as this usually causes the rest of the leaders to tangle up, and there is almost no safe place where to put such leaders without the constant fear of tangled lines and cuts with the sharpen points of fishing hooks. All the fisherman has to do is open the original package with the leaders and place then in the apparatus, this is done by simply inserting the sharp point of the hook in the open section in the body of the apparatus then exerting a pulling force while holding the line until the swivel reaches the outer extreme of the apparatus where an open section, teeth like, has been designed to hold the swivel. It could also be the other way around, by inserting the swivel first in the open section at the end of the apparatus and exerting a pushing force while holding the line until the sharp point of the hook reaches the open section in the body of the apparatus, where it should be inserted. The two pipe like sections of the apparatus articulates or slides one within the other and the apparatus has a spring inside so as to keep the leaders always stretched. The apparatus has several open sections in its body so as to house leaders of different sizes.

### STATEMENT REGARDING FEDERALLY SPONSORED RESEARCH OR DEVELOPMENT (“No Applicable”)

### THE NAMES OF THE PARTIES TO A JOINT RESEARCH AGREEMENT Hugo Bosch and Osvaldo Aguilar

### REFERENCE TO SEQUENCE LISTING, A TABLE, OR A COMPUTER PROGRAM LISTING COMPACT DISC APPENDIX (“No Applicable”)

### BACKGROUND OF THE INVENTION

Fisherman (including myself) consider a hassle the fact of transporting or carrying fishing leaders once is taken out of the original package, besides, and also not less important is the fact that when fisherman are in the middle of the fishing activity and a fish brakes the lines they would like to replace the leader that has just been lost as soon as possible. When I say that fisherman would like to replace the lost leader as soon as possible is because for fisherman time is gold and they want to keep the hook in the water with the least possible interruptions. When the time to replace a leader comes fisherman love to have a readily leader available, this is the time when this apparatus that I call FISHERMAN'S FLUTE due to its similarity with the musical instrument, shows to be of great help. Usually the experienced fishermen have several leaders hanging somewhere in the boat, 10 or more, and sincerely that works, but poses certain risk to other people in the boat as one leaders may accidentally fall without been noticed, but when the time to come back home arrives, those leaders must be returned to a safe place away from people's reach, also away from the natural corrosion environment surrounding the boat, usually salt water, at that time is when fishermen would love to have a place where to put the unused leaders one feet away from the other so as to avoid the unavoidable tangle, but that ample space usually does not exist in most boats and the idea simply does not make sense, under that simple circumstance I found myself many times, and the idea of this apparatus just came up as a natural solution, forced by the reality. I am just a fisherman who has encountered many headaches while engaged in the fishing activity, and I just imagine that this apparatus could be of great help to many others fishermen like me. This invention pertains to the marine utility apparatus.

### BRIEF SUMMARY OF THE INVENTION

An apparatus to carry or transport fishing leaders, among the advantages of this apparatus, I found the followings:

Fishing leaders can be stored in a secured manner, what I mean by “secured manner” is that the sharpen points of the hooks are totally hidden, therefore decreasing the chances of accidental injuries.

Fishing lines can be easily and elegantly transported in an orderly manner, I say orderly manner because the apparatus houses each leader in its own section and as the apparatus has a spring in its interior those leaders are kept in a stretched position all the time.

When fishermen are in the middle of the fishing activity they will have readily available those leaders, conveniently located somewhere in the boat, either in a horizontal position or hanging from the robe that the apparatus has in one of its points, the apparatus offers peace of mind, as the nightmare of tangled leaders disappears with the use of this simple apparatus.

### BRIEF DESCRIPTION OF THE SEVERAL VIEWS OF THE DRAWINGS

FIG. 1. Shows perspective view of the device.

FIG. 2. Shows a transparent view of the apparatus

FIG. 3 Shows a rope 1, conceived to hang the apparatus from a convenient place in the boat.

FIG. 4 Show a lateral view of one of the two PVC pipes that conform the apparatus. FIG. 4 also shows an elongated hole 2, where the sharpen points of the hooks should be inserted, FIG. 4 also shows a PVC ring 3 conceived to keep the longer section of the apparatus which is FIG. 4 perfectly inserted into the shorter part of the apparatus which is FIG. 5. It is important to point out that FIG. 4 slides or articulate inside FIG. 5, between the two rings 4 and 5

FIG. 5 Shows the shorter section of the apparatus which is also a PVC pipe. FIG. 5 also shows two PVC rings 4 and 5 whose task is to serve as a holding house for the spring so it does not come out of the apparatus. FIG. 5 shows a teeth like end 6 which is designed to hold the swivels, in other words, these are no more than smalls sections made on the end of the apparatus in order to accommodate the leaders. Leaders are a swivel, a fishing line or wire and a hook on the other end.

FIG. 6 Shows a spring whose task is to exert a constant upward pressure between ring 3 on FIG. 4 and ring 4 on FIG. 5, allowing an up and down movement of FIG. 4 inside FIG. 5 without coming out.

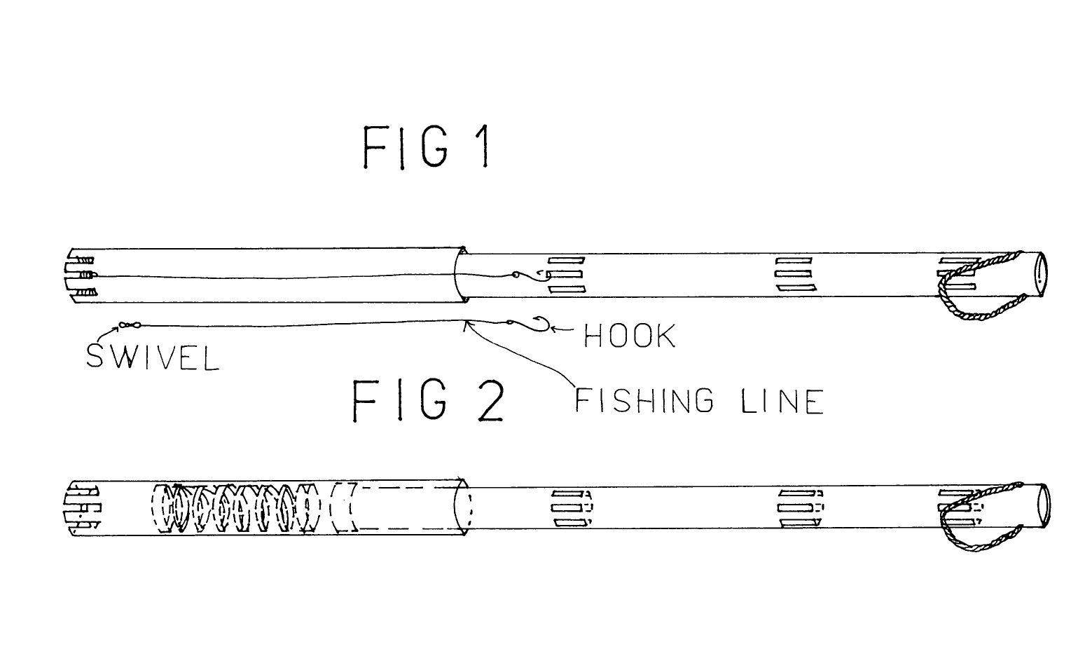

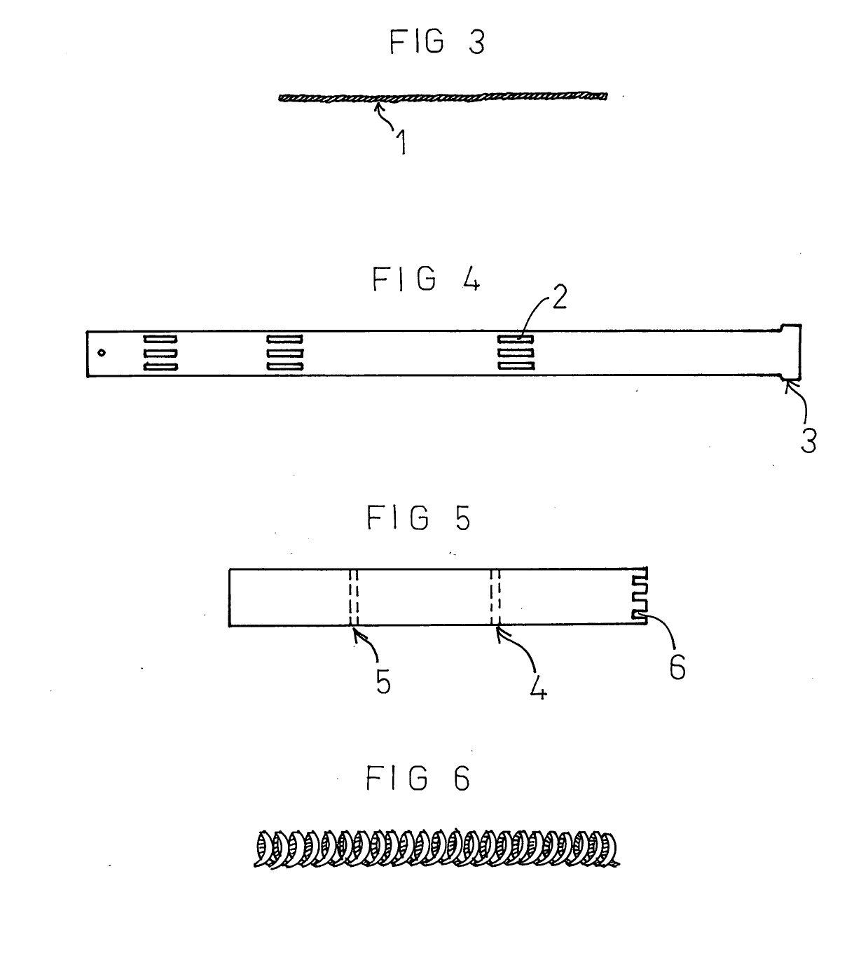

### DETAILED DESCRIPTION OF THE INVENTION

The apparatus is plastic, made out of two PVC pipes.

The apparatus is a marine utility, conceived to make the life easier to fishermen, why easier? Because fishermen need to have rapid access to leaders, they need to store those leaders for the next fishing experience, and all of this without tangled leaders. Today that is just a dream, and this apparatus is intended to make that dream come true. The way the apparatus works will be described below.

The fisherman takes the leader, insert the sharpen side of the hook into any of the open sections of the apparatus, exert a slight pressure to shrink the apparatus until the swivel reaches the teeth like end of the apparatus and insets swivel there, then releases the pressure and the spring inside the apparatus will be responsible to keep the leaders always stretched. The apparatus has a spring inside so as to keep the leaders always stretched. When someone exert a slight pressure against one end of the apparatus will feel an opposing force, trying to go back to the original position, this is because of the spring inside the apparatus. The apparatus is made out of two PVC pipes that articulate one within the other, they slide smoothly one within the other, no great force or pressure is necessary to make it shrink, and this shrinking action will only be necessary for 2 or 3 seconds until the swivel reaches the teeth like end of the apparatus.

The apparatus has several open sections or elongated holes in his body, so as to house leaders of different sizes.

The apparatus has two rings in its interior in order to house the spring inside the apparatus, these two rings will never let neither the spring to come out of the apparatus nor the two pipes of the apparatus to come apart, one pipe goes permanently inside the other, they will move or slide slightly one within the other but should never come apart.

What is claimed is:

1. An apparatus to transport or carry fishing leaders

2. The apparatus of claim 1 comprising two PVC pipes, that smoothly moves or slides one within the other.

3. The apparatus of claim 1 comprising several sections or elongated holes in his body, conveniently conceived to house fishing leaders of different sizes

4. The apparatus of claim 1 comprising a spring in its interior in order to keep the fishing leaders always stretched.
